(19) United States
(12) Patent Application Publication
(10) Pub. No.: US 2025/0379009 A1
(43) Pub. Date: Dec. 11, 2025

(54) OPERATING MECHANISM AND OPERATION INPUT DEVICE

(71) Applicant: AAC Technologies Pte. Ltd., Singapore (SG)

(72) Inventor: Kazuo Shikama, Osaka (JP)

(21) Appl. No.: 18/985,096

(22) Filed: Dec. 18, 2024

(30) Foreign Application Priority Data
Jun. 7, 2024 (JP) JP2024093352

(51) Int. Cl. H01H 13/20; A63F 13/24; H01F 7/20; H01H 13/14

(52) U.S. Cl. CPC H01H 13/20; A63F 13/24; H01F 7/20; H01H 13/14

(57) ABSTRACT

Disclosed are an operating mechanism and an operation input device. The operating mechanism includes: a housing having an accommodation space, a movable operating member received in the accommodation space and at least partially extending outside the housing, a support member configured to support the movable operating member. The movable operating member is movable around the support member. The operating mechanism includes a magnet connected to the movable operating member, and a magnetic member having a magnetic attraction to the magnet. The magnetic member and the magnet are configured to reset and/or hold the movable operating member in an initial position through the magnetic attraction. The operating mechanism according to embodiments of the present disclosure is resistant to vibration and drop impacts, the reliability of the operating mechanism is less affected by assembly processes, and high durability is achieved in response to user inputs.

### CROSS REFERENCE TO RELATED APPLICATIONS

This application claims priority to Japanese Patent Application No. JP2024093352, entitled “OPERATING MECHANISM AND OPERATION INPUT DEVICE,” filed on Jun. 7, 2024, which is incorporated by reference herein in its entirety.

### TECHNICAL FIELD

Embodiments of the present disclosure relate to the technical field of operating mechanisms, and in particular, to an operating mechanism and an operation input device.

### BACKGROUND

With the development of electronic technologies, electronic products have increasingly gained the attention of people. For example, electronic products, such as portable gaming consoles, stationary gaming consoles, in-vehicle devices, industrial operation equipment, and portable multimedia entertainment devices, typically require operating mechanisms to input user operation commands. Users expect that any number of operations on the operating mechanism can be effectively and reliably communicated to the system.

Currently, most conventional operating mechanisms utilize mechanical springs such as compression springs and torsion springs to maintain the operation at a neutral position, thus providing securing and support functions. However, mechanical springs may suffer damages due to impacts from drops, reciprocative motions caused by continuous user input or vibrations. Currently, structural stability tests such as life cycle tests and drop impact tests are commonly used to evaluate the reliability of mechanical springs, to ensure their stable usage.

Moreover, to manufacture springs that are resistant to vibrations and drop impacts, various parameters including spring diameter and material need to be rigorously designed. Consideration also needs to be given to potential issues such as spring bending, breaking, or damage during assembly, which may lead to reduced lifespan. Mechanical springs pose not only significant design challenges but also difficulties in ensuring the reliability of electronic products post-manufacturing.

Furthermore, even with the conventional operating mechanisms, it is often difficult to maintain appropriate resistance values for potentiometers or other resistance reading devices used for system inputs, which is because wear caused by repeated user inputs or interactions cause wear and consequently drifts are caused. That is, unintended user inputs, drift phenomenon caused by servo control's input to the system, and failures to respond correctly to inputs are also problems. These challenges are prevalent in the market. In this case, replacing individual potentiometers is difficult, and instead, the entire controller or some components of the controller need to be replaced.

Therefore, a moving part of the operating mechanism is kept at any position relative to an accommodating space. For example, in the case that an operation amount is at a minimum position, a support portion of a physical spring is constantly pushed or pressed by a force of the spring, causing friction and wear. Over time, the wear may lead to deformations, such that the mechanism may not remain at any position, such as the minimum operation position. As a result, in precision operations, it is necessary to implement remedial measures, such as setting a so-called dead zone or eliminating sensitivity at that position.

Thus, there is a need to provide a new operating mechanism that addresses the above problems.

### SUMMARY

Embodiments of the present disclosure provide an operating mechanism and an operation input device. The operating mechanism is resistant to vibration and drop impacts, the reliability of the operating mechanism is less affected by assembly processes, and high durability is achieved in response to user inputs.

In a first aspect, the embodiments of the present disclosure provide an operating mechanism. The operating mechanism includes:
a housing, having an accommodation space;
a movable operating member, received in the accommodation space and at least partially extending outside the housing;
a support member, configured to support the movable operating member, where the movable operating member is movable around the support member;
a magnet, connected to the movable operating member; and
a magnetic member, having a magnetic force to the magnet, where the magnetic member and the magnet are configured to reset and/or hold the movable operating member in an initial position under the magnetic force.

In some embodiments, a mounting position of the magnetic member corresponds to a position of the magnet in the case that the movable operating member is in the initial position.

In some embodiments, the magnetic member is spaced apart from the magnet.

In some embodiments, the operating mechanism further includes a connection member and an abutment member, where one end of the connection member is connected to the support member, the magnet is mounted at an end, away from the support member, of the connection member, and the abutment member is connected to a first end of the connection member and is configured to be abutted against the movable operating member; and under the magnetic force of the magnetic member with the magnet, the connection member is capable of moving around the support member to drive the abutment member to move and resetting and/or holding the movable operating member in the initial position.

In some embodiments, the operating mechanism further includes a circuit board and a first drive member connected to the circuit board, where the first drive member is arranged between the magnetic member and the magnet and is configured to adjust a position of the movable operating member.

In some embodiments, the magnetic member is a magnet sheet, where the magnet sheet is mounted on the first drive member or on an inner wall of the housing.

In some embodiments, the first drive member includes a first coil and a second coil respectively arranged on two sides of the magnet, where the first coil and the second coil are both electrically connected to the circuit board, and the two magnetic members are respectively arranged on a side, away from the magnet, of the first coil and a side, away from the magnet, of the second coil.

In some embodiments, the first coil and the second coil, upon energization, is capable of exhibiting magnetic force with the magnet, and the first coil and the second coil are capable of interacting with the magnet to function as a stopper and/or a vibration motor.

In some embodiments, the operating mechanism further includes a position detection element, where the position detection element is connected to the circuit board and is configured to detect displacement information of the movable operating member, and the circuit board is configured to convert the displacement information into a control signal and output the control signal.

In some embodiments, the movable operating member includes a moving part positioned inside the housing and a pressing part extending outside the housing, where a mounting portion is arranged in the moving part, and the magnet is embedded inside the mounting portion.

In some embodiments, the operating mechanism further includes a second drive assembly arranged on a bottom or a side of the movable operating member, where the second drive assembly is capable of moving in a direction toward or away from the movable operating member and interfering with the movable operating member capable of rotating in a movable direction.

In some embodiments, the second drive assembly includes a drive motor and a contact portion, where under a drive action of the drive motor, the contact portion is capable of interfering with the movable operating member, and a contact surface of the contact portion is spherical or chamfered.

In some embodiments, the support member is a support shaft, and the housing includes a first shell and a second shell, where a first securing portion is arranged in the first shell, a second securing portion is arranged in the second shell, a shaft hole is defined in the movable operating member. The support shaft is capable of passing through the shaft hole of the movable operating member, and two ends of the support shaft are respectively mounted and secured into the first securing portion and the second securing portion. The movable operating member is capable of moving around the support shaft.

In a second aspect, the embodiments of the present disclosure provide an operation input device. The operation input device includes the operating mechanism according to the first aspect.

As compared to the related art, the present disclosure at least achieves the following beneficial effects.

In the operating mechanism according to the embodiments of the present disclosure, the magnetic member configured to control the movable operating member is not a physical spring, but a magnetic member employing the magnetic force, which exerts the magnetic force to the magnet connected to the movable operating member. In this way, the movable operating member is capable of being reset and/or held in the initial position. As compared to force feedback of the movable operating member using a physical spring, magnetic cooperation between the magnetic member and the magnet reduces interference and friction therebetween. Even undergoing a drop impact, the movable operating member is still capable of automatically returning to the initial position under the magnetic force. This design greatly improves durability, impact and drop resistance performance, and wear resistance of the operating mechanism, and thus improves lifespan of the operating mechanism.

### BRIEF DESCRIPTION OF THE DRAWINGS

For clear descriptions of the technical solutions according to the embodiments of the present disclosure, drawings that are to be referred for description of the embodiments are briefly described hereinafter. Apparently, the drawings described hereinafter merely illustrate some embodiments of the present disclosure. Persons of ordinary skill in the art may also derive other drawings based on the drawings described herein without any creative effort.

FIG. 1A is a perspective view of an operating mechanism according to a first embodiment of the present disclosure;

FIG. 1B is a front view of the operating mechanism according to the first embodiment of the present disclosure;

FIG. 1C is a side view of the operating mechanism according to the first embodiment of the present disclosure;

FIG. 2 is a schematic exploded structural diagram of the operating mechanism according to the first embodiment of the present disclosure;

FIG. 3 is a schematic diagram of an operating mechanism according to a second embodiment of the present disclosure;

FIG. 4 is a schematic diagram of an operating mechanism according to a third embodiment of the present disclosure;

FIG. 5 is a schematic diagram of an operating mechanism according to a fourth embodiment of the present disclosure;

FIG. 6 is a schematic diagram of an operating mechanism according to a fifth embodiment of the present disclosure;

FIG. 7A is a schematic diagram of an operating mechanism according to a sixth embodiment of the present disclosure;

FIG. 7B is another schematic diagram of the operating mechanism according to the sixth embodiment of the present disclosure;

FIG. 7C is still another schematic diagram of the operating mechanism according to the sixth embodiment of the present disclosure;

FIG. 8 is a schematic structural diagram of an operation input device according to some embodiments of the present disclosure;

FIG. 9 is a schematic structural diagram of the operation input device according to some embodiments of the present disclosure; and

FIG. 10 is another schematic structural diagram of the operation input device according to some embodiments of the present disclosure.

### REFERENCE NUMERALS AND DENOTATIONS THEREOF

100—operating mechanism;
1—housing;
11—first shell; 111—first securing portion; 112—first accommodation portion;
12—second shell; 121—second securing portion; 122—second accommodation portion;
2—movable operating member;
20—movable direction; 201—initial position; 202—full stroke stop position; 203—arbitrary stop position; 21—shaft hole;
22—moving part; 221—mounting portion; 23—pressing part;
3—support member;
4—magnet;
5—magnetic member;
6—first drive member; 61—first coil; 62—second coil;
7—circuit board; 71—first electrical connection portion; 72—second electrical connection portion;
8—position detection element;
9—second drive member; 90—first direction; 91—drive motor; 92—contact portion; 93—second direction;
101—connection member; 102—abutment member; 103—connection portion; 104—rotation shaft; 105—third direction;
200—operation input device.

### DETAILED DESCRIPTION

For clearer descriptions of the objectives, technical solutions, and advantages of the present disclosure, the present disclosure is further described with reference to specific embodiments and attached drawings. It should be understood that the specific embodiments described herein are only intended to explain the present disclosure instead of limiting the present disclosure.

In the description of the present disclosure, unless explicitly defined otherwise, the terms “first,” “second,” and the like are used for descriptive purposes only and should not be interpreted as indicating or implying relative importance. Unless otherwise specified or described, the term “plurality” refers to two or more, and the term “variety” refers to two or more types. The terms “connect,” “secure,” and similar terms and derivative forms thereof should be broadly interpreted. For example, “connect” may refer to a fixed connection, a detachable connection, an integrated connection, or an electrical connection; it can be a direct connection or an indirect connection through an intermediate medium. Persons of ordinary skill in the art may understand the specific meanings of the above terms in the present disclosure according to the actual circumstances and contexts.

In the description of the specification, it should be understood that the words indicative of orientations and directions, such as “up,” “down,” and the like are described with reference to angles illustrated in the accompanying drawings and should not be interpreted as limiting the embodiments of the present disclosure. Furthermore, it should also be understood from the context that when a member or element is described as being connected to another member or element, the member or element may not only be directly connected to the other member or element, but may also be indirectly connected through an intermediate member or element to the other member or element.

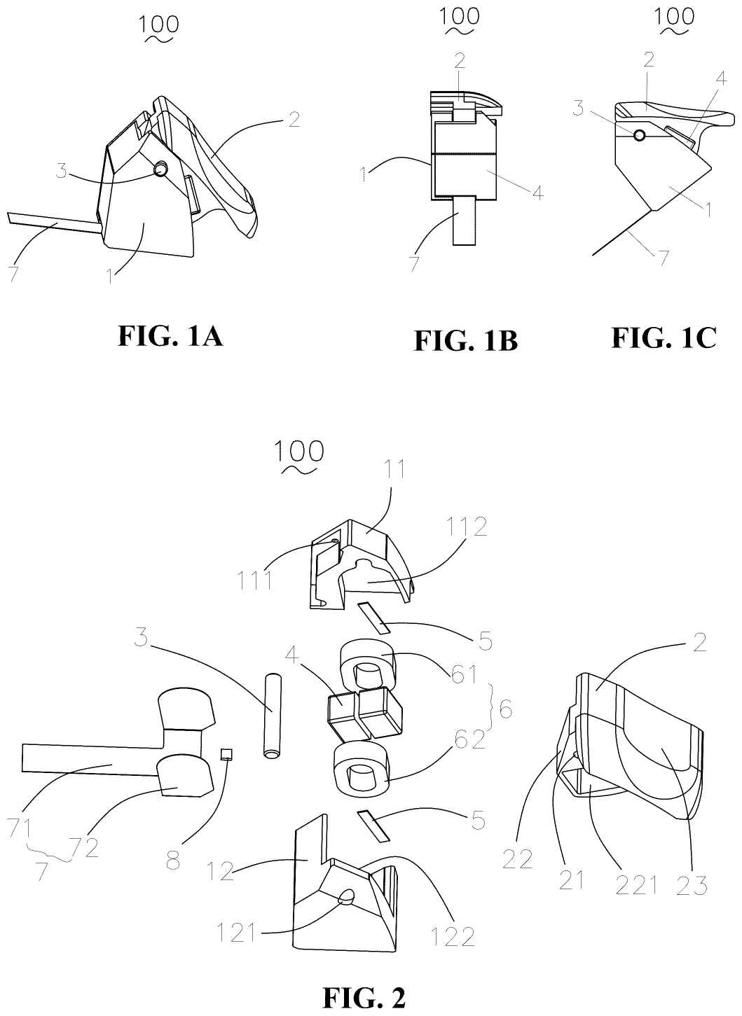

FIG. 1A is a perspective view of an operating mechanism according to a first embodiment of the present disclosure. FIG. 1B is a front view of the operating mechanism according to the first embodiment of the present disclosure. FIG. 1C is a side view of the operating mechanism according to the first embodiment of the present disclosure. FIG. 2 is a schematic exploded structural diagram of the operating mechanism according to the first embodiment of the present disclosure. This embodiment provides an operating mechanism 100. The operating mechanism 100 includes a housing 1, a movable operating member 2, a support member 3, a magnet 4, and a magnetic member 5.

An accommodation space is defined in the housing, and the movable operating member 2 is received in the accommodation space and at least partially extending outside the housing 1. The support member 3 is configured to support the movable operating member 2, and the movable operating member 2 is capable of moving around the support member 3. The magnet 4 is connected to the movable operating member 2. The magnetic member 5 exhibits a magnetic force to the magnet 4, and the magnetic member 5 and the magnet 4 are configured to reset and/or hold the movable operating member in an initial position under the magnetic force.

In the operating mechanism according to the embodiment of the present disclosure, the magnetic member 5 configured to control the movable operating member 2 is not a physical spring, but a magnetic member 5 employing the magnetic force, which exerts the magnetic force to the magnet 4 connected to the movable operating member 2. In this way, the movable operating member 2 is capable of being reset and/or held in the initial position. As compared to force feedback of the movable operating member using a physical spring, magnetic cooperation between the magnetic member 5 and the magnet 4 reduces interference and friction therebetween. Even undergoing a drop impact, the movable operating member 2 is still capable of automatically returning to the initial position under the magnetic force. This design greatly improves durability, impact and drop resistance performance, and wear resistance of the operating mechanism, and thus improves lifespan of the operating mechanism.

At present, an electroactuator is typically employed to feed back inputs of a user to the operation input device, for example, inputs when the user is playing games. In the embodiments of the present disclosure, by the interaction between the magnet 4 and the magnetic member 5, force feedback may be provided for inputs of a user to the operating mechanism 100, and some rules may be defined in a control program to adjust the level of force feedback based on an input amount (a pressing force) of the user. Hence, the magnet 4 and the magnetic member 5 cooperate to serve as the electroactuator, and thus force feedback is achieved, thereby improving overall durability of the structure.

As illustrated in FIG. 2, the operating mechanism 100 includes a housing 1 in which an accommodation space is defined. The housing 1 includes a first shell 11 and a second shell 12. The first shell 11 and the second shell 12 are coupled and engaged to form the housing 1. The accommodation space inside the housing 1 is designed to accommodate structures such as the magnet 4 and the movable operating member 2 in a way that is compatible with these structures.

Specifically, a first securing portion 111 is arranged in the first housing 11, and a second securing 121 is arranged in the second shell 12, and two ends of the support member 3 are respectively mounted and secured in the first securing portion 111 and the second securing portion 121. The first securing portion 111 and the second securing portion 121 may be shaft holes, circular grooves, pin holes, or the like, and the support member 3 is capable of rotating in the first securing portion 111 and the second securing portion 121.

In some embodiments, the support member 3 may be a support shaft or a support ball, and the support member 3 may also be any other structure capable of supporting and bearing the movable operating member 2 as long as it is ensured that the movable operating member 2 is capable of moving around the support member 3, which is not limited herein.

The support member 3 is configured to support the movable operating member 2, and the movable operating member 2 is capable of rotating and moving around the support member 3. This embodiment uses the support shaft as an example. Two ends of the support shaft are respectively inserted into the first securing portion 111 and the second securing portion 121. The first securing portion 111 and the second securing portion 121 are cylindrical grooves or circular holes, and a shaft hole is defined in the movable operating member 2. The support shaft is capable of rotating, and thus driving the movable operating member 2 to rotate around the support shaft.

Still referring to FIG. 2, the movable operating member 2 includes a moving part 22 arranged inside the housing 1 and a pressing part 23 extending outside the housing 1. The extension length and shape of the moving part 22 are not limited in the present disclosure. The moving part 22, when receiving a force generated by the pressing part 23, drives the magnet 4 to rotate around the support member 3 and generate a torque. In this case, a reaction torque, a vibration force, or a reaction force when acting as a stopper are improved.

The moving part 22 is a rectangular frame structure, and a mounting portion is arranged in the moving part 22. The magnet 4 is embedded in the mounting portion 221, such that the magnet 4 is detachably connected to the movable operating member 2. The mounting portion 221 may be a mounting hole or a mounting groove, which is not limited herein in terms of specific form. It should be understood that even though the magnet 4 is damaged, quick and convenient replacement is also achieved. In some other embodiments, the magnet 4 may also be mounted in the accommodation space in the housing 1, as long as the magnet 4 remains to be connected to the movable operating member 2 and synchronously rotates with the movable operating member 2. The magnet 4 may be cube-shaped, ring-shaped, cylinder-shaped, or the like, which is not limited herein.

For ease of operation by the user, a portion, extending outside the housing 1, of the movable operating member 2 is the pressing part 23. The pressing part 23 may be a groove or recess that fits the shape of the user's finger, such that the user is allowed to quickly press the movable operating member 2.

In the embodiments of the present disclosure, in order to enhance a magnetic strength of the magnet 4, two rectangular magnets 4 are embedded in the mounting portion 221 of the movable operating member 2. In the case that the user presses the pressing part 23 of the movable operating member 2, the movable operating member 2 moves and rotates around the support member 3 from its initial position, and drives the magnet 4 to move.

In some embodiments, a mounting position of the magnetic member 5 corresponds to a position of the magnet 4 in the case that the movable operating member 2 is in the initial position. The initial position in the embodiments of the present disclosure refers to the position where the movable operating member 2 is located when it is not pressed by the user, which may also be understood as a no-load position.

In some embodiments, the magnetic member 5 and the magnet 4 on the movable operating member 2 are spaced apart, which helps to better reduce friction and wear, thereby extending the lifespan of the magnetic member 5. Additionally, the required mounting space is reduced, and structural compactness of the operating mechanism is improved. In feasible implementations, the magnetic member 5 is mounted on an inner wall of the housing 1. The magnetic member 5 may be formed by magnetic sheets, with two magnetic sheets respectively mounted on inner walls of the first housing 11 and the second housing 12. The magnetic member 5 and the magnet 4 on the movable operating member 2 are spaced apart, and the magnetic member 5 attracts the magnet 4 under a magnetic force.

Since the magnetic member 5 is arranged close to the initial position of the movable operating member 2, in the case that the movable operating member 2 rotates to other positions, the magnetic force between the magnetic member 5 and the magnet 4 drives the movable operating member 2 to actively reset. The magnetic member 5 thus provides a non-physical and magnetic spring effect, such that drifts caused by wear during position detection and damage caused by vibration or drop impact are reduced.

During use, in the case that the user presses on the pressing part 23 of the movable operating member 2, under an applied pressing force, the movable operating member 2 rotates along the support member 3. In the case that the user releases the pressing force, the movable operating member 2 resets to its initial position under the magnetic force of the magnetic member 5. In practice, by adjusting the mounting angle, shape, and distance between the magnetic member 5 and the magnet 4, the magnetic force of the magnetic member 5 may be modified. The magnetic member 5, formed by magnetic sheets, is spaced from the magnet 4 and is not easily subject to wear. Even though the operating mechanism 100 undergoes a drop or vibration, the magnetic member 5 is less likely to suffer any damage. In this way, the structural reliability is significantly improved.

In some embodiments, the operation mechanism 100 further includes a first drive member 6 and a circuit board 7. To enable the first drive member 6 to electrically generate a magnetic field, the first drive member 6 is electrically connected to the circuit board 7. The first drive member 6 is arranged between the magnetic member 5 and the magnet 4, and is configured to adjust the position of the movable operating member 2.

In a feasible solution, the first drive member 6 is arranged within the accommodation space, and the first drive member 6 is a coil. Upon being energized, the coil generates a magnetic field, and the magnet 4 interacts with the magnetic field generated by the first drive member 6 to create magnetic force (magnetic attraction), and thus adjust the position of the movable operating member 2.

As illustrated in FIG. 2, the first shell 11 is provided with a first accommodation portion 112, and the second shell 12 is provided with a second accommodation portion 122. Correspondingly, the first drive member 6 includes a first coil 61 and a second coil 62. The first coil 61 is mounted in the first accommodation portion 112, and the second coil 62 is mounted in the second accommodation portion 122. The first coil 61 and the second coil 62 are arranged on two sides of the magnet 4, such that the magnetic attraction therebetween is enhanced, and thus the movement of the movable operating member 2 is controlled. In this case, the magnetic member 5 may be mounted on the first drive member 6, and positioned on a side, away from the magnet 4, of the first drive member 6.

In the embodiments of the present disclosure, the circuit board 7 is connected to a power supply device (not illustrated in the drawings). The circuit board 7 is a flexible printed circuit board with excellent bend-resistance performance which allows to adjust its mounting position according to the space within the housing. Specifically, the circuit board 7 includes a first electrical connection portion 71 and two second electrical connection portions 72. The first electrical connection portion 71 extends to the exterior of the housing 1 and is connected to the power supply device, and the two second electrical connection portions 72 are respectively in contact with the sides, away from the magnet, of the first coil 61 and the second coil 62. In the case that the first coil 61 and the second coil 62 receive a current input from the circuit board 7, the first drive member 6 generates a magnetic force on the magnet 4. The magnitude of the magnetic force generated by the coils is proportional to the current applied to a voice coil motor. By controlling the input current, the strength of the magnetic force generated by the coils is controlled. This magnetic force interacts with the magnet, such that a reaction force is provided to the movable operating member 2, and the movable operating member 2 is enabled to return from the pressed position to the initial position thereof or adjust and control its rotation position, thereby improving the user experience.

In some embodiments, the operating mechanism 100 further includes a position detection element 8 electrically connected to the circuit board 7. The position detection element 8 is configured to detect displacement information of the movable operating member 2. The circuit board 7 is further configured to convert the displacement information into a control signal and output the control signal to an external device. In specific embodiments, the position detection element 8 is mounted within the accommodation space, and is capable of detecting the position of the magnet 4 based on the strength of the magnetic field (the Hall effect), that is, any position of the movable operating member 2 within its movable range.

During use, in the case that the user presses the pressing part 23 of the movable operating member 2, the movable operating member 2 rotates around the support member 3. The displacement of the magnet 4 is detected in real time by the position detection element 8, and a threshold of any position where the magnet 4 is located is input to the external device. The displacement of the movable operating member 2 is closely monitored based on the input data.

To control a movement amount of the movable operating member 2, the real-time position of the movable operating member 2 is detected by the position detection element 8, and the first drive member 6 magnetically interacts with the magnet 4 to control the movable operating member 2 to stop at any position within its movable range. In this case, the first drive member 6 may act as a stopper, and control the magnet 4 on the movable operating member 2 by virtue of a reaction force provided by the first drive member 6, such that the movable operating member 2 is allowed to stop at any position.

In other embodiments, a mechanical stopper may also be mounted in the operating mechanism 100 to stop the movable operating member at any position, without using any coils. Alternatively, an electromechanical driver (such as a motor) may be used in combination with the coils to enable the operating mechanism to provide force feedback.

Additionally, the interaction between the first drive member 6 and the magnet 4 may also serve as a vibration motor, which produces a click sound. For example, by applying a current to the first drive member 6 within the movable range of the movable operating member 2, a vibration sensation is generated, which is fed back to the magnet 4 inside the movable operating member 2. This feedback is further transmitted to the pressing part 23, such that the user is allowed to experience vibrations and sound effects.

In the embodiments of the present disclosure, the position detection element 8 is capable of detecting the position of the movable operating member 2 without physical contact. Unlike conventional detection elements such as potentiometers, the position detection element 8 in the embodiments of the present disclosure does not cause friction or wear with the movable operating member 2. In this way, drift issues are prevented and precise detection is ensured without causing structural damage, thereby improving the reliability of the operating mechanism 100.

In the embodiments of the present disclosure, the position of the movable operating member 2 is detected by the position detection element 8, and information of the position is fed back to the control center. The control center controls the movable operating member 2 to stop at any given position based on the magnetic field generated by the first drive member 6, thereby achieving electric control over the pressing amount of the movable operating member. Compared to manual input control using the mechanical stopper, the electric control greatly enhances the case of use.

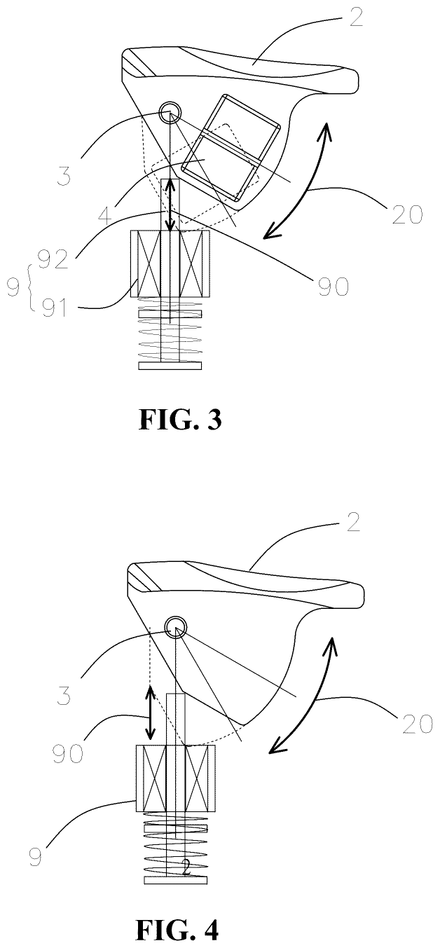

FIG. 3 is a partial perspective view of an operating mechanism 100 according to a second embodiment of the present disclosure. As illustrated in FIG. 3, the operating mechanism 100 further includes a second drive member 9, arranged at the bottom of the movable operating member 2, to control the movement or stopping of the movable operating member 2 within the movable range. It should be understood that the first drive member 6 in the solution according to the first embodiment may be replaced by the second drive member 9, or the second drive member 9 may work in conjunction with the first drive member 6 to control the movement of the movable operating member 2.

As illustrated in FIG. 3, the second drive member 9 is arranged at the bottom of the movable operating member 2. The second drive member 9 is capable of moving in a direction towards or away from the movable operating member 2 (a first direction 90) and interfere with the movement of the movable operating member 2 in a movable direction 20. Specifically, the second drive member 9 includes a drive motor 91 and a contact portion 92. The contact portion 92 is capable of moving in the first direction 90 under the action of the drive motor 91 and interfering with the movement of the movable operating member 2 in the movable direction 20. It should be understood that in the case that the movable operating member 2 comes into contact with the second drive member 9, the first drive member 6 in the solution according to the first embodiment of the present disclosure may be replaced by the second drive member 9 to implement the functions of force feedback and stopping. In other embodiments, the second drive member 9 and the first drive member 6 may be cooperatively used to control different motion paths and more complex movement directions. When both members are cooperatively used, the force feedback effect and stopping functionality are significantly enhanced.

FIG. 4 is a schematic partial structural view of an operating mechanism 100 according to a third embodiment of the present disclosure. As illustrated in FIG. 4, the operating mechanism 100 includes a second drive member 9 and a first drive member 6. The first drive member 6 is a coil, and is capable of generating a magnetic force on the magnet 4, and hence providing a reaction force to the movable operating member 2. This enables the movable operating member 2 to return from any stop position to its initial position or to adjust or control its stop position. The second drive member 9 is capable of moving in the first direction 90, and the movable operating member 2 is capable of rotating in the movable direction 20 and coming into contact with the second drive member 9 moving in the first direction 90. The second drive member 9 is capable of functioning as a vibration motor, such that the movable operating member 2 is capable of vibrating vertically, thereby providing the user with a tactile vibration sensation. In this embodiment, the first direction 90 refers to a vertical direction, either towards or away from the movable operating member 2.

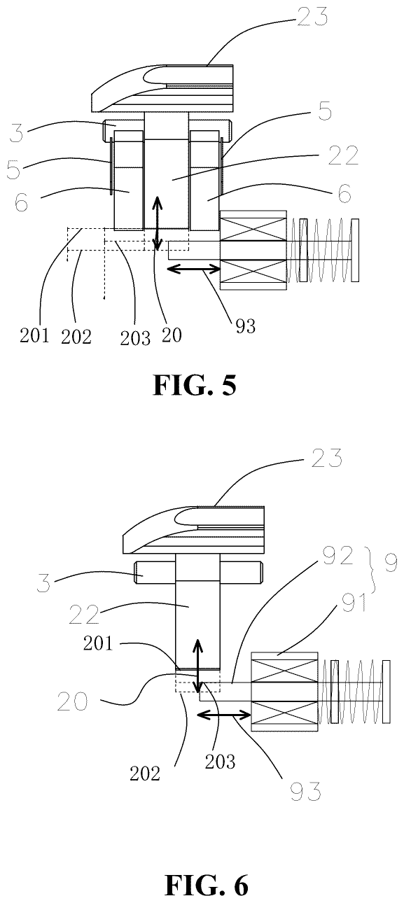

FIG. 5 is a schematic diagram of an operating mechanism 100 according to a fourth embodiment of the present disclosure. As illustrated in FIG. 5, the operating mechanism 100 includes a second drive member 9 arranged on the side of the movable operating member 2. The second drive member 9 includes a drive motor 91 and a contact portion 92. The contact portion 92 is capable of moving in a direction towards or away from the movable operating member 2 (a second direction 93) and interfering with the rotation of the movable operating member 2 in the movable direction. Specifically, the contact portion 92, which is movable in the second direction 93, is capable of abutting against the moving part of the movable operating member 2. In the case that the pressing part 23 of the movable operating member 2 receives a pressing force, the moving part 22 rotates around the support member 3 and is capable of rotating in the movable direction 20 from an initial position 201 to a full-travel stop position 202. In the case that the contact portion 92 of the second drive member 9 moves in the second direction 93 and interferes with the moving part 22, the moving part 22 is capable of stopping at any position 203 within the movable range. In this case, the second drive member 9 is capable of functioning as a stopper.

FIG. 6 is a schematic diagram of an operating mechanism 100 according to a fifth embodiment of the present disclosure. As illustrated in FIG. 6, the mechanism 100 includes a second drive member 9, with no first drive member 6 (coil). In this embodiment, the second drive member 9 is arranged within the accommodating space of the housing 1 and positioned on one side of the moving part 22 of the movable operating member 2. The contact portion 92 of the second drive member 9 is capable of moving in the second direction 93 under the action of the drive motor 91, and interfering with the moving part 22 of the movable operating member 2 moving in the movable direction 20. The second drive member 9 is capable of functioning as a vibration motor, such that the movable operating member 2 is capable of vibrating laterally, thereby providing the user with a tactile vibration sensation. The second direction 93 refers to a direction towards or away from the movable operating member 2, and is perpendicular or approximately perpendicular to the moving part 22.

In this embodiment, the contact surface of the contact portion 92 may be designed as a spherical surface or chamfered arc surface, such as cut at a 45-degree angle. In this way, a collision force between the contact portion 92 and the movable operating member 2 is reduced, and wear is minimized. Lateral interference generated by the second drive member 9 may produce a lateral reaction force, such that the movable operating member 2 is capable of vibrating laterally and hence functioning as a lateral vibration motor.

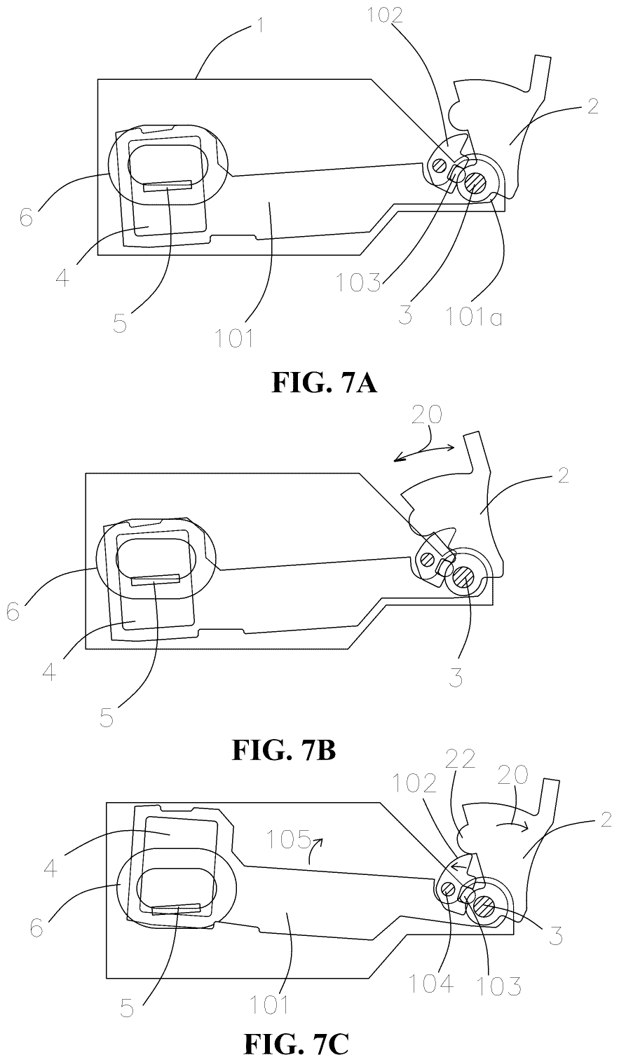

FIG. 7A, FIG. 7B, and FIG. 7C are schematic diagrams of an operating mechanism 100 according to a sixth embodiment of the present disclosure. As illustrated in these figures, the operating mechanism 100 further includes a connection member 101 and an abutment member 102. A first end 101a of the connection member 101 is connected to the support member 3, and the magnet 4 is mounted at an end, opposite to the support member 3, of the connection member 101. The abutment member 102 is connected to the first end 101a of the connection member 101 and is configured to abut against the movable operating member 2.

In the above solution, the magnet 4 is mounted on the connection member 101 and is capable of transmitting a magnetic attraction force between the magnet 4 and the magnetic element 5 to the movable operating member 2 via the abutment member 102. This assists in resetting the movable operating member 2 or achieving force feedback. Compared to force feedback based on a physical spring, the magnetic attraction between the magnetic element 5 and the magnet 4 reduces interference and friction therebetween. Even being subjected to impacts from a fall, the movable operating member 2 is still capable of automatically returning to its initial position due to the magnetic attraction of the magnetic element 5, regardless of its position within the movable range.

In some embodiments, the connection member 101 is a linkage. A shaft hole and a connection portion 103 are arranged at a first end 101a of the linkage. The support member 3 passes through the shaft hole in the connection member 101, such that the connection member 101 is capable of rotating around the support member 3. A rotation shaft 104 is further arranged on the inner wall of the housing 1. The abutment member 102 is sleeved onto the rotation shaft 104 and is connected to the connection portion 103 in the connection member 101. In the case that the connection member 101 rotates around the support member 3 in a third direction 105, the abutment member 102 is driven to move around the rotating shaft 104 in a direction opposite the third direction 105.

In some embodiments, as illustrated in FIG. 7B, the first drive member 6 may be a coil. In the case that the coil is not energized, the user may manually push the movable operating member 2 to move freely within the movable range.

In other embodiments, the first drive member 6 may also be a coil. As illustrated in FIG. 7C, in the case that the coil is energized, a magnetic force generated interacts with the magnet 4 through magnetic attraction. Under this magnetic attraction, the connecting member 101 is capable of rotating around the support member 3 in the third direction 105, and transmitting a reaction force to the moving part 22 of the movable operating member 2 via the abutment member 102. This allows the movable operating member 2 to return to its initial position from a pressed position or enables adjustment and control of its movement position.

In the above embodiments, the operating mechanism, compared to traditional operating mechanisms in variable tactile feedback controllers, features a simpler, more compact, and lightweight overall structure. This operating mechanism is resistant to vibration and drop impacts, and its reliability is less affected by assembly processes, high durability is achieved in response to user inputs.

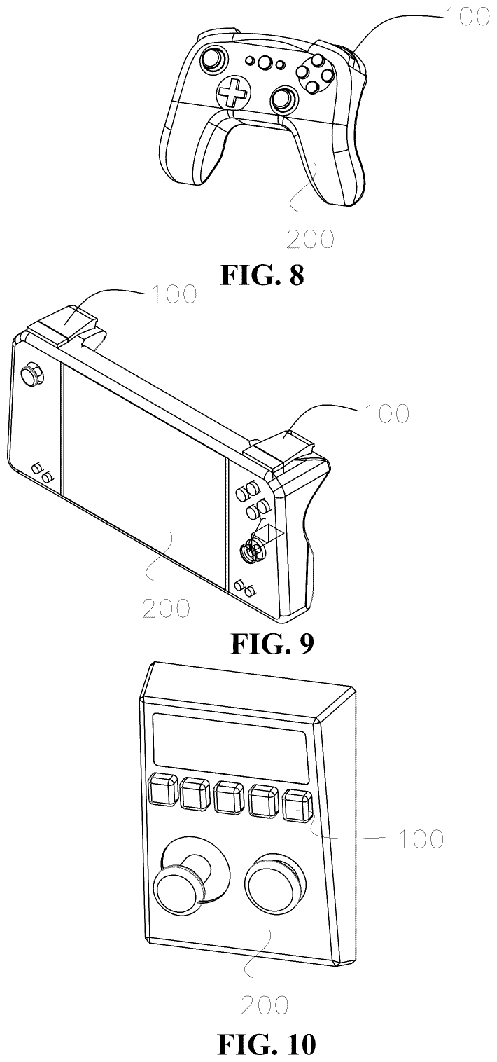

FIG. 8 is a schematic structural diagram an operation input device according to the present disclosure. FIG. 9 is another schematic structural diagram of the operation input device according to the present disclosure. FIG. 10 is yet another schematic structural diagram of the operation input device according to the present disclosure. As illustrated in FIG. 8 to FIG. 10, the present disclosure further provides an operation input device 200. The operation input device 200 includes any of the operating mechanisms 100 described above. The operation input device 200 is capable of functioning as a game controller, which facilitates user's operation. The operating mechanism 100 may also be used in game controller units as illustrated in FIG. 5 or in portable information devices. As illustrated in FIG. 10, the operating mechanism 100 may be mounted into the operation input devices 200 of other industrial equipment, such as processing or measurement equipment. The application of the operating mechanism 100 enhances the controllability and durability of the operation input device 200.

The above embodiments are used only for illustrating the present disclosure, but are not intended to limit the protection scope of the present disclosure. Various modifications and replacements readily derived by those skilled in the art within technical disclosure of the present disclosure shall fall within the protection scope of the present disclosure. Therefore, the protection scope of the present disclosure is subject to the appended claims.

What is claimed is:

1. An operating mechanism, comprising:
a housing, having an accommodation space;
a movable operating member, received in the accommodation space and at least partially extending outside the housing;
a support member, configured to support the movable operating member, wherein the movable operating member is movable around the support member;
a magnet, connected to the movable operating member; and
a magnetic member, having a magnetic force to the magnet, wherein the magnetic member and the magnet are configured to reset and/or hold the movable operating member in an initial position under the magnetic force.

2. The operating mechanism according to claim 1, wherein a mounting position of the magnetic member corresponds to a position of the magnet in the case that the movable operating member is in the initial position.

3. The operating mechanism according to claim 2, wherein the magnetic member is spaced apart from the magnet.

4. The operating mechanism according to claim 1, further comprising: a connection member and an abutment member; wherein
one end of the connection member is connected to the support member, the magnet is mounted at an end, away from the support member, of the connection member, and the abutment member is connected to a first end of the connection member and is configured to be abutted against the movable operating member; and
under the magnetic force of the magnetic member with the magnet, the connection member is capable of moving around the support member to drive the abutment member to move and resetting and/or holding the movable operating member in the initial position.

5. The operating mechanism according to claim 1, further comprising: a circuit board and a first drive member connected to the circuit board, wherein the first drive member is arranged between the magnetic member and the magnet and is configured to adjust a position of the movable operating member.

6. The operating mechanism according to claim 5, wherein the magnetic member is a magnet sheet, and the magnet sheet is mounted on the first drive member or on an inner wall of the housing.

7. The operating mechanism according to claim 5, wherein the first drive member comprises a first coil and a second coil respectively arranged on two sides of the magnets, the first coil and the second coil are both electrically connected to the circuit board, and the two magnetic members are respectively arranged on a side, away from the magnet, of the first coil and a side, away from the magnet, of the second coil.

8. The operating mechanism according to claim 7, wherein the first coil and the second coil, upon energization, is capable of exhibiting magnetic force with the magnet, and the first coil and the second coil are capable of interacting with the magnet to function as a stopper and/or a vibration motor.

9. The operating mechanism according to claim 5, further comprising: a position detection element, wherein the position detection element is connected to the circuit board and is configured to detect displacement information of the movable operating member, and the circuit board is configured to convert the displacement information into a control signal and output the control signal.

10. The operating mechanism according to claim 1, wherein the movable operating member comprises a moving part positioned inside the housing and a pressing part extending outside the housing, a mounting portion is arranged in the moving part, and the magnet is embedded inside the mounting portion.

11. The operating mechanism according to claim 1, further comprising: a second drive assembly arranged on a bottom or a side of the movable operating member, wherein the second drive assembly is capable of moving in a direction toward or away from the movable operating member and interfering with the movable operating member capable of rotating in a movable direction.

12. The operating mechanism according to claim 11, wherein the second drive assembly comprises a drive motor and a contact portion, wherein under a drive action of the drive motor, the contact portion is capable of interfering with the movable operating member, and a contact surface of the contact portion is spherical or chamfered.

13. The operating mechanism according to claim 1, wherein
the support member is a support shaft, and the housing comprises a first shell and a second shell; wherein
a first securing portion is arranged in the first shell, a second securing portion is arranged in the second shell, a shaft hole is defined in the movable operating member, the support shaft is capable of passing through the shaft hole of the movable operating member, and two ends of the support shaft are respectively mounted and secured into the first securing portion and the second securing portion; and
the movable operating member is capable of moving around the support shaft.

14. An operation input device, comprising the operating mechanism according to claim 1.

15. The operation input device according to claim 14, wherein a mounting position of the magnetic member corresponds to a position of the magnet in the case that the movable operating member is in the initial position.

16. The operation input device according to claim 15, wherein the magnetic member is spaced apart from the magnet.

17. The operation input device according to claim 14, wherein the operating mechanism further comprises: a connection member and an abutment member; wherein
one end of the connection member is connected to the support member, the magnet is mounted at an end, away from the support member, of the connection member, and the abutment member is connected to a first end of the connection member and is configured to be abutted against the movable operating member; and
under the magnetic force of the magnetic member with the magnet, the connection member is capable of moving around the support member to drive the abutment member to move and resetting and/or holding the movable operating member in the initial position.

18. The operation input device according to claim 14, wherein the operating mechanism further comprises: a circuit board and a first drive member connected to the circuit board, wherein the first drive member is arranged between the magnetic member and the magnet and is configured to adjust a position of the movable operating member.

19. The operation input device according to claim 18, wherein the magnetic member is a magnet sheet, and the magnet sheet is mounted on the first drive member or on an inner wall of the housing.

20. The operation input device according to claim 18, wherein the first drive member comprises a first coil and a second coil respectively arranged on two sides of the magnets, the first coil and the second coil are both electrically connected to the circuit board, and the two magnetic members are respectively arranged on a side, away from the magnet, of the first coil and a side, away from the magnet, of the second coil.
